(19) United States
(12) Patent Application Publication
(10) Pub. No.: US 2008/0111783 A1
(43) Pub. Date: May 15, 2008

(54) Method and system for adjusting luminance of a cold cathode fluorescent lamp

(75) Inventor: Shu-Wen Chuang, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/595,927

(22) Filed: Nov. 13, 2006

(51) Int. Cl. G09G 3/36

(52) U.S. Cl. 345/102

(57) ABSTRACT

A method and system for adjusting the luminance of a cold cathode fluorescent lamp (CCFL) is provided, which operates in a BIOS of a liquid crystal screen in a computer-executable way. A plurality of sets of time-luminance values of the CCFL is stored in the BIOS. First, the image quality of the liquid crystal screen is detected with a current image, and if the image quality is poor, a current time value and a current actual luminance value of the liquid crystal screen are then detected, and a plurality of sets of time-luminance values of the CCFL are searched, according to which the voltage of the CCFL is adjusted such that the current actual luminance value is adjusted accordingly. Therefore, by implementation of the method and system, the phenomenon of luminance reduction over time when using a liquid crystal screen with a CCFL is avoided.

### BACKGROUND OF THE INVENTION

1. Field of Invention

The present invention relates to a method for adjusting the luminance of a display screen, and more particularly, to a method and system for adjusting the luminance of a liquid crystal screen with a cold cathode fluorescent lamp (CCFL).

2. Related Art

The liquid crystal display (LCD) has occupied the consumer information market to a great extent, since it has the advantages of being light, thin, short, and small, having low heat and electricity consumption, as well as being radiation-free. Among such LCDs, a thin film transistor liquid crystal display (TFT-LCD) technology has developed rapidly, which declares the beginning of a high-quality display era with actual investment scale and yield performance. The LCD is not a self-emissive display, and thus requires to be supplied with uniform and adequate lighting to provide the luminance of a liquid crystal screen. The light source of an LCD is generally a back light with high luminance and long life time. The current light sources include cold cathode fluorescent lamp (CCFL), hot cathode fluorescent lamp, electro-luminescent lamp (EL), and light emitting diode (LED), wherein the CCFL occupies the largest proportion of production yields due to its lighter weight, less heat emitting, and high efficiency in photoelectric conversion, and the like, and now 99% of commercial LCD backlights are the CCFL. The CCFL tube is fully filled with inert gases and micro amount of mercury, with the fluorescent powder coated on inner walls of the glass tube. When a high voltage is applied to electrodes on both ends of the tube, both polarities are beginning to discharge, and then the mercury will be activated due to a mutual collision between electrons or atoms of the filled inert gases, and will emit ultraviolet light (with the wave length of 253.7 nm), which activates the fluorescent powder to emit the light.

However, there is a problem about the life time of the CCFL. As shown in FIG. 1, it is a comparative table 10 of a time-luminance relationship of the CCFL, and as can be known that, the luminance of the liquid crystal screen will decrease with time, that is, as the time passes, the luminescent of the liquid crystal screen decreases. Assumed that an initial luminance is set to 400 cd/m², the luminance will reduce to 200 cd/m² which is 50% of the initially set luminance value, after a continuous use of about 50000 hours. With a powering-on time period of 20 hours each day, the luminance of the display will reduce to a half (200 cd/m²) of the initial value six years later, and it is generally referred to as a life cessation, which is a point at which the luminance of the lamp reduces to 50% of the initial one. At this time, the CCFL cannot be used any more since it has reached its life limit. In addition, it is indicated by the data of FIG. 1 that, the luminance of the LCD reduces from an initial value 400 cd/m² to about 330 cd/m² after a continuous working of 5000 hours, and to 80% of the initial luminance value after 10000 hours. Therefore, the problem that the luminance of the CCFL decreases with time not only affects the life time of the LCD, but also deteriorates the image quality of the liquid crystal screen, which brings visual difference and discomfort to long-time users for the display glow-started by a CCFL, and even results in damage to eyesight. A general solution is to replace the CCFL or the display in advance, such that the utilization ratio of the display is reduced, resulting in waste to a certain extent.

### SUMMARY OF THE INVENTION

An object of the present invention is to provide a method and system for adjusting the luminance of a cold cathode fluorescent lamp (CCFL) in order to solve problems and defects in the above-mentioned conventional art. The disclosed method and system for adjusting the luminance of the CCFL compensates a luminance difference of a liquid crystal screen in time by adjusting a voltage value of the CCFL, thereby preventing the problem of luminance reduction as the time increases.

The method and system for adjusting the luminance of the CCFL disclosed in the present invention is carried out in a BIOS of the liquid crystal screen in a computer-executable way, wherein a plurality of sets of time-luminance values for the CCFL are stored in the BIOS. This method includes the following steps: capturing a current image of the liquid crystal screen and detecting the image quality of the liquid crystal screen; if the image quality is poor, detecting a current time value and a current actual luminance value of the liquid crystal screen; and searching a plurality of sets of time-luminance values for the CCFL, according to which the voltage of the CCFL is adjusted, such that the current actual luminance value will be adjusted accordingly.

In the method and system for adjusting the luminance of the CCFL according to the present invention, the luminance of the liquid crystal screen in different time periods is simulated based on voltage values of the CCFL in different time periods, thereby a plurality of sets of time-luminance values of the CCFL are obtained.

Furthermore, a system for adjusting the luminance of the CCFL is further provided in the present invention, which operates in a BIOS of a liquid crystal screen in a computer-executable way, and a plurality of sets of time-luminance values for the CCFL are stored in the BIOS, This system includes: a detecting module, a measuring module, and an adjusting module; wherein, the detecting module is used to capture a current image of the liquid crystal screen and to detect the image quality of the liquid crystal screen through the current image; the measuring module is used to measure a current time value and a current actual luminance value of the liquid crystal screen; and the adjusting module is used to search a plurality of sets of time-luminance values for the CCFL, according to which the voltage of the CCFL is adjusted, such that the current actual luminance value can be adjusted accordingly.

The present invention can be used to detect the quality of the liquid crystal screen with a CCFL over time, and to adjust a current voltage value of the CCFL through a plurality of sets of time-luminance values for the CCFL such that a timely adjustment can be made to its luminance, thus avoiding a phenomenon of the luminance reduction as time increases when using a display device with a CCFL backlight. Not only is the utilization ratio of the display enhanced, but also an adverse effect on the user's eyesight can be avoided.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a comparative table of a time-luminance relationship of a cold cathode fluorescent lamp (CCFL);

FIG. 2 is a block diagram of a system for adjusting the luminance of a CCFL of the present invention; and

FIG. 3 is a flow chart of a method for adjusting the luminance of a CCFL of the present invention.

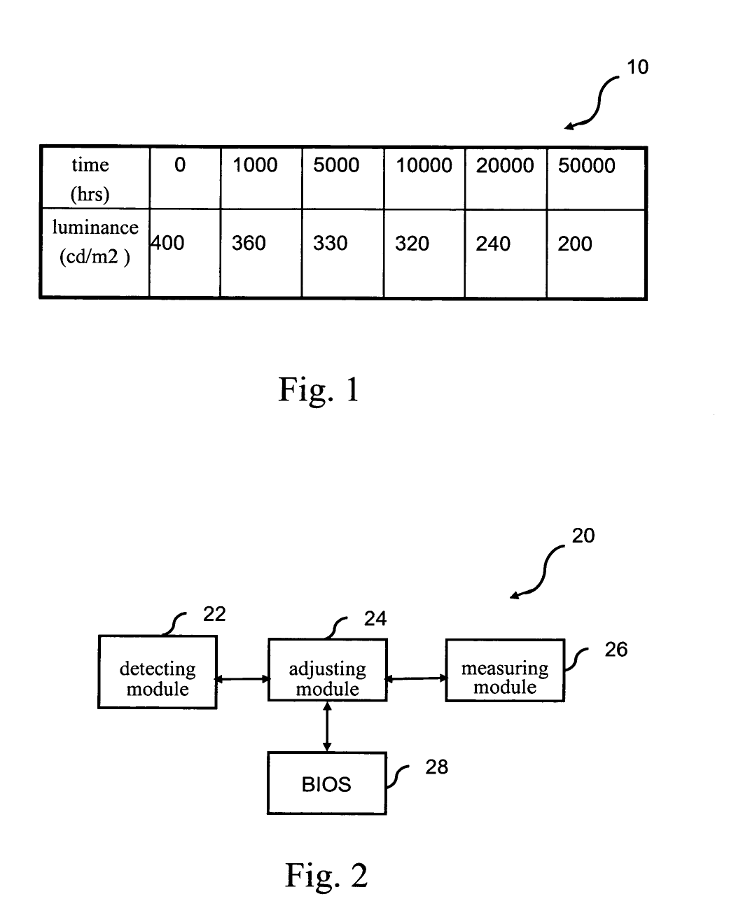

### DETAILED DESCRIPTION OF THE INVENTION

The preferred embodiments of the present invention will be illustrated below in detail with reference to the accompanying drawings.

Referring to FIG. 2, it is a block diagram of a system for adjusting the luminance of a CCFL of the present invention, as shown in the figure, a luminance adjusting system 20 includes a detecting module 22, an adjusting module 24, and a measuring module 26. First, the detecting module 22 captures a current image of the liquid crystal screen within a predetermined time period, and then detects the quality of the captured image. Here, the detecting module 22 can carry out the detection operation according to a user's current selection, or through setting a certain time interval with a piece of software, for example, after continuous use of the LCD for 20 hours, the detecting module 22 will be enabled to automatically carry out the detection operation within the predetermined time period. Here, the detected image quality includes the luminance and contrast of the liquid crystal screen, which are key factors for influencing the image quality of the screen. Certainly, in an appropriate circumstance, other factors, such as color, saturation, etc. of the screen also can be considered. An LCD typically achieves a preset optimal value of the luminance, which is about 55% of the highest luminance. As time increases, a change will occur to achieve the selected optimal luminance. Therefore, the fact whether or not a luminance of the LCD will reduce is determined by detecting the image quality of the liquid crystal screen. If the image quality detected by the detecting module 22 is poor, the measuring module 26 will begin to measure a current time value and a current actual luminance value of the liquid crystal screen and to send the acquired time value and actual luminance value into the adjusting module 24. The adjusting module 24 searches a plurality of sets of time-luminance values for the CCFL stored in a basic input and output system (BIOS) 28, and a corresponding relationship between time and luminance can be found out through a series of experiments before the liquid crystal display products leave factory. Here, the luminance of the liquid crystal screen in different time periods is simulated based on the voltage values of the CCFL in different time periods. Although an LCD is a digital display, the luminance of each pixel is actually determined by the analog voltage level stored in a pixel unit, and the color is realized by utilizing a RGB filter in front of the pixel, such that the luminance of the CCFL is simulated based on the selected voltage, and the color is realized by utilizing a RGB filter in front of the pixel, such that the luminance of the CCFL is represented by the selected voltage. The adjusting module 24 finds out a time-luminance value corresponding to a current time from the BIOS according to the received time value and luminance value, and adjusts the voltage of the CCFL, thereby adjusting the current actual luminance.

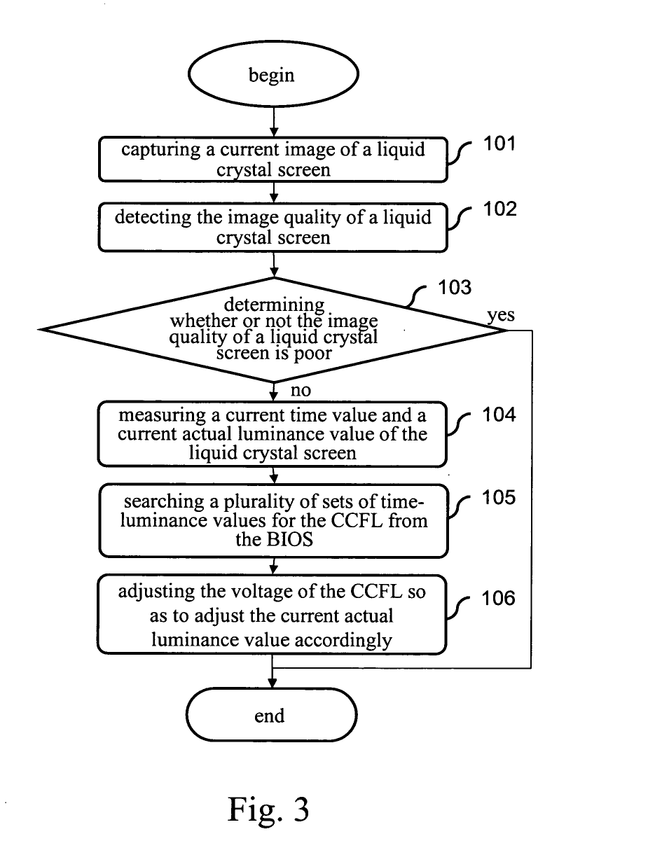

FIG. 3 is a flow chart of a method for adjusting the luminance of a CCFL according to the present invention. As shown in the figure, first, a current image of the liquid crystal screen is captured (Step 101). Next, the quality of the captured image of the liquid crystal screen is detected (Step 102). Here, the detected image quality includes luminance and contrast of the liquid crystal screen. In Step 103, the image quality of the liquid crystal screen is good or not is determined, and the criteria for determining the image-playing quality of the display are luminance and contrast of the liquid crystal screen, which are the two factors with the most significant influence on the display quality. If the luminance is too low, the contrast will be reduced, and if the luminance is too high, a fuscous background will become relatively pale. Higher the contrast is, much clearer an image will be. When the contrast rises up to a certain extent, a problem with the purity of the color will occur. Therefore, when the quality of the current image is determined to be poor, a current time value and a current actual luminance value of the liquid crystal screen are detected (Step 104). Then, a plurality of sets of time-luminance values stored in the BIOS are searched (Step 105), and a software program used to carry out a searching process first browses a comparative table of a plurality of sets of time-luminance values pre-stored in a storage device of the LCD, wherein the luminance of the liquid crystal screen in different time periods is simulated based on the voltage values of the CCFL in different time periods, thereby a plurality of sets of time-luminance values for the CCFL are obtained, and finally the voltage of the CCFL is adjusted through the measured current time value and current actual luminance value of the liquid crystal screen, such that the current actual luminance value is adjusted accordingly (Step 106). The time for detecting the image quality of the liquid crystal screen can be predetermined, for example, the detection process will be automatically conducted after continuous working of the display for 20 hours. If the detected image quality is poor, the current time value and the actual luminance value of the screen will be sequentially measured. The luminance in each area of the liquid crystal screen can be controlled by adjusting the current and voltage of the CCFL, for example, an inverter circuit of the CCFL and a digital control circuit for controlling the operation of the CCFL are actuated according to the detected time period. After adding a lighting pattern output from the digital control circuit to the inverter circuit, according to different patterns, a corresponding change occurs in voltage of a transformer of the inverter circuit, and thereby the luminance of the CCFL changes accordingly. Thus, a luminance adjustment to the CCFL is achieved and the image quality is improved. Here, the above-mentioned function of adjusting the voltage of the CCFL can be achieved through a software program cured within the BIOS, such that a timely detection and adjustment can be made to the luminance of the LCD by utilizing the time state, thus ensuring that the liquid crystal screen carries out the displaying process with a preferred range of luminance.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for adjusting the luminance of a cold cathode fluorescent lamp (CCFL), which operates in a BIOS of a liquid crystal screen in a computer-executable way, wherein a plurality of sets of time-luminance values for the CCFL are stored in the BIOS, the method comprising the following steps:
capturing a current image of the liquid crystal screen, and detecting the image quality of the liquid crystal screen;
if the image quality is poor, detecting a current time value and a current actual luminance value of the liquid crystal screen; and
searching the plurality of sets of time-luminance values for the CCFL, and adjusting the voltage of the CCFL according to the plurality of sets of time-luminance values for the CCFL, thereby adjusting the current actual luminance value accordingly.

2. The method for adjusting the luminance of the CCFL as claimed in claim 1, wherein the luminance of the liquid crystal screen in different time periods is simulated based on the voltage values of the CCFL in different time periods, such that the plurality of sets of time-luminance values for the CCFL are obtained.

3. The method for adjusting the luminance of the CCFL as claimed in claim 1, wherein the image quality refers to the luminance of the liquid crystal screen.

4. The method for adjusting the luminance of the CCFL as claimed in claim 1, wherein the image quality refers to the contrast of the liquid crystal screen.

5. A system for adjusting the luminance of a CCFL, which operates in a BIOS of a liquid crystal screen in a computer-executable way, wherein a plurality of sets of time-luminance values for the CCFL are stored in the BIOS, the system comprising:
a detecting module, for capturing a current image of the liquid crystal screen, and detecting the image quality of the liquid crystal screen through the current image;
a measuring module, for measuring a current time value and a current actual luminance value of the liquid crystal screen; and
an adjusting module, for searching the plurality of sets of time-luminance values for the CCFL, and adjusting a voltage value of the CCFL according to the plurality of sets of time-luminance values for the CCFL, so as to adjust the current actual luminance value accordingly.

6. The system for adjusting the luminance of the CCFL as claimed in claim 5, wherein the luminance of the liquid crystal screen in different time periods is simulated based on the voltage values of the CCFL in different time periods, such that the plurality of sets of time-luminance values for the CCFL are obtained.

7. The system for adjusting the luminance of the CCFL as claimed in claim 5, wherein the image quality refers to the luminance of the liquid crystal screen.

8. The system for adjusting the luminance of the CCFL as claimed in claim 5, wherein the image quality refers to the contrast of the liquid crystal screen.
